(19) United States
(12) Patent Application Publication
(10) Pub. No.: US 2007/0296822 A1
(43) Pub. Date: Dec. 27, 2007

(54) Method and device for wireless video communication

(76) Inventors: Yin-Chun Blue Lan, Wurih Township (TW); Chih-Ta Star Sung, Glonn (DE); Wei-Ting Cho, Taichung (TW)

Correspondence Address: Chih-Ta Star SUNG;RM. 308, BLD. 52, NO. 195, CHUNG HSING RD., SEC. 4, JHU DONG TOWNSHIP, HSINCHU COUNTY, 310, omitted

(21) Appl. No.: 11/449,883

(22) Filed: Jun. 9, 2006

(51) Int. Cl. H04N 5/232

(52) U.S. Cl. 348/211.99

(57) ABSTRACT

The captured video will be compressed group by group and transmitted to the receiver through wireless transceiver. The mechanism of the wireless video communication includes the defining of whether or not to request resend when data loss or data damage happened. When the time of the data loss or data damage happened is more than the predetermined threshold, the video will be compressed by further lower bit rate. Areas of the captured image with more interest will be compressed by assigning more bit rate. The area of less interest will be compressed with less bit rate and transmitted. One of every predetermined amount of images will be shrunk and displayed in the smaller area of the display device to let the video shooter view the position the image is captured and decides whether the position results in good image quality.

### BACKGROUND OF THE INVENTION

1. Field of Invention

The present invention relates to the video compression techniques, and particularly relates to the video compression and decompression method and device specifically for wireless data stream transmission and results in good noise immunity and less impact when data loss happened during transmission.

2. Description of Related Art

In the past decades, the semiconductor migration trend has driven wireless communication technology to be more convenient with less expensive and wider bandwidth which coupled with sharp quality of LCD display have driven the digital audio and video wireless communication to be more attractive.

Wireless communication technology including Wireless LAN (802.11x), Blue Tooth, DECT, RF have made audio and video data transmission and receiving through air feasible. The audio and video data stream can be transmitted through air to the destination under communication protocols. The audio or video player with wireless receiver has convenience in handless and good mobility. Wireless audio and video communication also plays more and more critical role in future digital home, portable media devices and video mobile phone.

Due to the limitation of available bandwidth of the wireless communication protocols, the audio and video data, especially the later have to be compressed before transmit to the destination and being decompressed by a receiving end in the destination. The technique of compression reduces the data rate of audio and video. The prior art wireless audio and video communication systems just transmits audio and video data stream to the destination by using most likely video compression technology like MPEG or motion JPEG as shown in FIG. 1. It is not uncommon that data got lost or damaged during wireless transmission. Due to the lack of efficient error correction in wireless communication, the MPEG and motion JPEG are inefficient in wireless video communication and easily cause much error and propagated from one frame to other frames in MPEG.

This invention takes new alternative and more efficiently and easily overcomes the data loss or data damage risk in wireless communication. Even data loss or damage happen, it quickly recovers the lost or damaged data to a high degree of similarity which minimizes the need of requesting “Re-send” times.

### SUMMARY OF THE INVENTION

The present invention of the audio and video compression for wireless transmission specifically designed for wireless data stream transmission and has good noise immunity which can also recovered quickly and accurately from data loss and data damage.
The present invention of the audio and video compression for wireless transmission compresses a predetermined amount of pixels within the predetermined region with a predetermined data rate.
According to an embodiment of this invention, pixels within the more interested area will be given higher bit number to achieve better image quality, and the region of not interested will be given less bit number.
According to an embodiment of this invention, the image sensor captures the image and compares to a predetermined image and signals “Good quality” to the user if he/she is shooting video with region within the predetermined location which results in good quality.
According to an embodiment of this invention, not all but some blocks of pixels within predetermined regions will be compressed and transmitted to the destination.
According to an embodiment of this invention, when the receiver detects data loss, it will examine whether it needs to request of “Re-send” or skipping it and throw away future coming data till the beginning of the next group of pixels.
According to an embodiment of this invention, when data loss happened, and the times of re-send has reached a threshold, the sub-sampling method or higher compression rate will be applied to reduce the data rate.
According to an embodiment of this invention, the received compressed image is sent to the display device and if the display device does not have the decompression engine, the compression image will be decompressed before driving out to the display panel, if the display device has the decompression engine, then, the compressed image will be sent to the display device for decompression and display.

Other aspects and advantages of the present invention will become apparent from the following detailed description, taken in conjunction with the accompanying drawings, illustrating by way of example the principles of the invention. It is to be understood that both the foregoing general description and the following detailed description are by examples, and are intended to provide further explanation of the invention as claimed.

### BRIEF DESCRIPTION OF THE DRAWINGS

FIG. 1 depicts a prior art wireless audio-video transmission system.

FIG. 2A depicts a prior art video compression method, a motion JPEG video compression procedure.

FIG. 2B depicts a prior art video compression method, an MPEG video compression standard.

FIG. 3 illustrates method of this invention with bit rate of a predetermined amount of pixels having predetermined data rate, for example, a line with 2-10 times compression rate.

FIG. 4 illustrates the region of more interest which is allowed higher data rate for gaining better image quality.

FIG. 5 illustrates user's captured image tolerance compared to the region of interest of a video stream.

FIG. 6 shows more specific area of interest which might apply more bit rate during compression to allow higher image quality.

FIG. 7 illustrates the audio and video interlacing in compressed mode.

FIG. 8 illustrates the block diagram of the procedure of receiving the compressed A-V data and the mechanism of separating audio and video and decoding before displaying.

FIG. 9 illustrates the procedure of receiving compression audio and video data and the mechanism of handling data loss.

FIG. 10 illustrates two principles of the sub-sampling

FIG. 11 illustrates the frame based sub-sampling

### DESCRIPTION OF THE PREFERRED EMBODIMENTS

The popularity of wireless communication devices and protocols including Wireless LAN (802.11x), Blue Tooth, DECT, RF have made audio and video stream data transmission through the air possible. The wireless data transmission has played critical role in audio communication, and video communication will follow in the next decade.

Due to the limitation of bandwidth and huge amount of audio and video stream data to be traveling in the air, the data loss or data damage rate during wireless transmission is high. Some wireless communication protocols have defined the mechanisms of handling the data loss or data damage. Most of them include the CRC checking which is to check the data to determine whether the data amount is right or wrong. When data is wrong, some mechanisms might be enabled to correct the lost or damaged data including “request of re-send” or “Error Correction Coding” algorithms. No matter whether the correction or re-sending mechanism, as data loss or damage happened, the correction mechanism takes long delay time to recover or to correct.

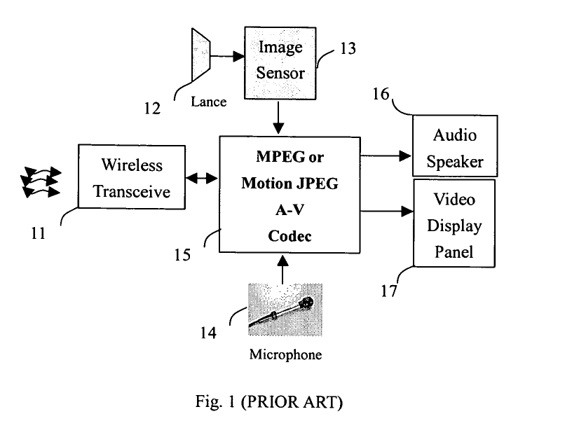

Due to the huge amount of audio and video raw data to be traveling in the air during wireless transmission, in some applications, the video and audio data are compressed before being transmitted to the destination which has a receiver with decompression engine to recover the compressed audio and video data streams. In prior art approaches of wireless audio and video stream transmission, as shown in FIG. 1, the MPEG and motion JPEG 15 are commonly used solutions. An image is input through a lance 12 and being captured by an image sensor array 13 before going through the compression procedure. The audio inputting from a microphone 14 is compressed by an audio compression codec 15 which might use the same engine like MPEG or motion JPEG. The compressed audio and video stream data is then packed and send to the destination through the wireless transceiver 11. In reserve data flow direction, the compressed audio and video receiving from the wireless transceiver 11 will be sent to the audio and video codec 15 for recovering before being displayed onto the video display panel 17 and to the audio speaker 16. The MPEG is a motion video compression standard set by ISO which uses previous or/and next frame as referencing frames to code the pixel information of the present frame, any error of video stream will be propagated to the next frames of image and degrades the quality gradually. The motion JPEG has less impact of data loss or data damage since the block of image is coded independent on other frame. Nevertheless, the JPEG is a widely accepted international image compression standard, hence, most engines are designed following the standard bit stream format, therefore, any data loss or damage cause fatal error in decoding the rest of the block pixels within an image.
Drawback of the prior art wireless audio and video system with MPEG or motion JPEG compression algorithms includes the possible loss of the stream data with no mechanism of correction and the data rate will be higher if error correction code is included in the stream. Another side effect of the prior art video playback system is that an MPEG picture uses previous frame of image as reference, any error in a frame of pixels can be propagated to the next following frames of pictures and causes more and more distortion in further frames. JPEG picture is coded by intra-coded mode which does not rely on other frame than itself.

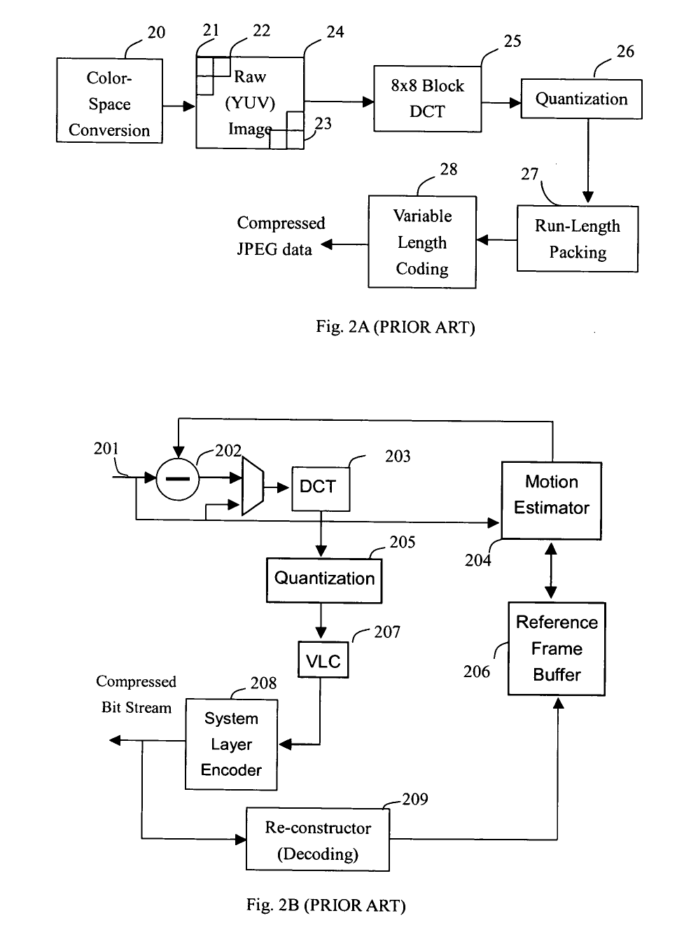

JPEG image compression as shown in FIG. 2A includes some procedures in image compression. The color space conversion 20 is to separate the luminance (brightness) from chrominance (color) and to take advantage of human being's vision less sensitive to chrominance than to luminance and the can reduce more chrominance element without being noticed . An image 24 is partitioned into many units of so named “Block” of 8×8 pixels to run the JPEG compression. A color space conversion 10 mechanism transfers each 8×8 block pixels of the R (Red), G (Green), B (Blue) components into Y (Luminance), U (Chrominance), V (Chrominance) and further shifts them to Y, Cb and Cr. JPEG compresses 8×8 block of Y, Cb, Cr 21, 22, 23 by the following procedures:
Step 1: Discrete Cosine Transform (DCT)
Step 2: Quantization
Step 3: Zig-Zag scanning
Step 4: Run-Length pair packing and
Step 5: Variable length coding (VLC).

DCT 25 converts the time domain pixel values into frequency domain. After transform, the DCT “Coefficients” with a total of 64 sub-bands of frequency represent the block image data, no longer represent single pixel. The 8×8 DCT coefficients form the 2-dimention array with lower frequency accumulated in the left top corner, the farer away from the left top, the higher frequency will be. Further on, the more closer to the left top, the more DC frequency which dominates the more information. The more right bottom coefficient represents the higher frequency which less important in dominance of the information. Like filtering, quantization 26 of the DCT coefficient is to divide the 8×8 DCT coefficients and to round to predetermined values. Most commonly used quantization table will have larger steps for right bottom DCT coefficients and smaller steps for coefficients in more left top corner. Quantization is the only step in JPEG compression causing data loss. The larger the quantization step, the higher the compression and the more distortion the image will be.

After quantization, most DCT coefficient in the right bottom direction will be rounded to “Os” and only a few in the left top corner are still left non-zero which allows another step of said “Zig-Zag” scanning and Run-Length packing 27 which starts left top DC coefficient and following the zig-zag direction of scanning higher frequency coefficients. The Run-Length pair means the number of “Runs of continuous Os”, and value of the following non-zero coefficient.

The Run-Length pair is sent to the so called “Variable Length Coding” 28 (VLC) which is an entropy coding method. The entropy coding is a statistical coding which uses shorter bits to represent more frequent happen patter and longer code to represent the less frequent happened pattern. The JPEG standard accepts “Huffman” coding algorithm as the entropy coding. VLC is a step of lossless compression.

The JPEG compression procedures are reversible, which means the following the backward procedures, one can decompresses and recovers the JPEG image back to raw and uncompressed YUV (or further on RGB) pixels.

FIG. 2B illustrates the block diagram and data flow of a prior art MPEG digital video compression procedure, which is commonly adopted by compression standards and system vendors. This prior art MPEG video encoding module includes several key functional blocks: The predictor 202, DCT 203, the Discrete Cosine Transform, quantizer 205, VLC encoder 207, Variable Length encoding, motion estimator 204, reference frame buffer 206 and the re-constructor (decoding) 209. The MPEG video compression specifies I-frame, P-frame and B-frame encoding. MPEG also allows macro-block as a compression unit to determine which type of the three encoding means for the target macro-block. In the case of I-frame or I-type macro block encoding, the MUX selects the coming pixels 201 to go to the DCT 203 block, the Discrete Cosine Transform, the module converts the time domain data into frequency domain coefficient. A quantization step 205 filters out some AC coefficients farer from the DC corner which do not dominate much of the information. The quantized DCT coefficients are packed as pairs of “Run-Level” code, which patterns will be counted and be assigned code with variable length by the VLC Encoder 207. The assignment of the variable length encoding depends on the probability of pattern occurrence. The compressed I-type or P-type bit stream will then be reconstructed by the re-constructor 209, the reverse route of compression, and will be temporarily stored in a reference frame buffer 206 for future frames' reference in the procedure of motion estimation and motion compensation. As one can see that any bit error caused by data loss or damage in MPEG stream header information will cause fatal error in decoding and that tiny error in data stream will be propagated to following frames and damage the quality significantly

To overcome the drawback of the wireless transmitting the audio data stream, this invention separates a group of audio samples into sub-groups of audio samples and compresses these sub-groups independently before transmitting. Any damage happened to the audio sample by EMI or any other interference within one sub-group, the adjacent audio samples are decompressed and used to interpolate and recover the lost or damaged audio sample which will be most likely having value very close to the lost/damaged audio sample. The above procedure of audio compression and recovering the lost or damaged audio samples will be applied to the situation of multiple data loss within a pack of audio stream and the adjacent audio samples are used to recover the lost/damaged audio stream data. For accelerating the speed of recovering the lost data when a certain amount of audio samples within a pack data stream are lost or damaged, the nearest sub-group of the audio data samples can be applied to substitute the lost/damaged pack of audio stream.

Since the wireless transmission has high potential of hitting high air traffic jam, a controller which periodically detects the air traffic condition before transmitting the compressed audio stream, will inform the audio and video compression engine about the air traffic condition. Should the air traffic is busy and the compressed audio and video stream is not available to be transmitted, the compression engine will reduce the pack length of the existing and further pack of audio and video samples by half till the traffic jam is lessened. The minimum length of each pack of sub-group of samples is predetermined by detecting the traffic condition where the system is located. And the minimum number can be adjusted over time. When air traffic gets better, the pack length is doubled every time when it transmitted a last pack of compressed audio samples.

An image source sending to be displayed will be firstly compressed by a compression engine before temporarily saving to the frame buffer which most likely an SRAM memory array. When the timing of display reached, the corresponding group of pixels will be recovered by the decompression engine and feed to the display source driver to be display onto the display panel. The gate drivers decide the row number for those corresponding row of pixels to be displayed on the display panel. A timing control unit calculates the right timing of displaying the right line of pixels stored in the frame buffer, sends signal to the frame buffer and the decompression engine to inform the status of display. For instance, send an “H-Sync” signal to represent a new line needs to be display within a certain time slot. When the decompression engine receives this signal, it starts accessing the frame buffer and decompressing the compressed pixel data and recovers the whole line of pixels and send them to the source driver unit for display.

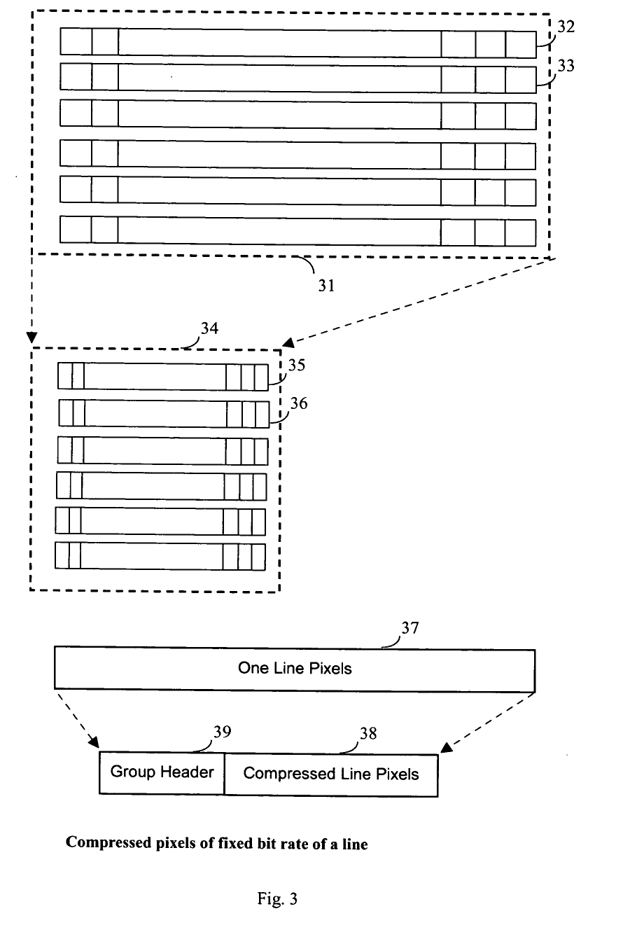

In this invention of the video wireless communication, to minimize the impact of image quality during data loss or data damage, a predetermined amount of pixels is compressed with predetermined bit rate. Should the data loss or damage happened in the air, the current group of pixels could be discarded and use the same group pixels in previous frame for display instead. FIG. 3 depicts the conceptual block diagram of one approach of this invention. A frame of image 31 is comprised of said hundred of lines 32, 33 of pixels with each line having the same amount of pixels. For instance, a resolution of 320×240 (SIF or QVGA resolution), a frame has 240 lines pixels with each line of 320 pixels which comes out of a total of 76,800 pixels. Each line 35, 36 of pixels might be compressed with a predetermined bit rate and come out of a compressed frame 34 with a fixed frame data rate. In some applications, the group of pixels can be defined as block of M×N pixels, or several of lines or segments of pixels with a group header 39 having group information followed by compressed data 38. The header information might include amount of pixels in a group, compression rate, location of groups, quantization step. . . .

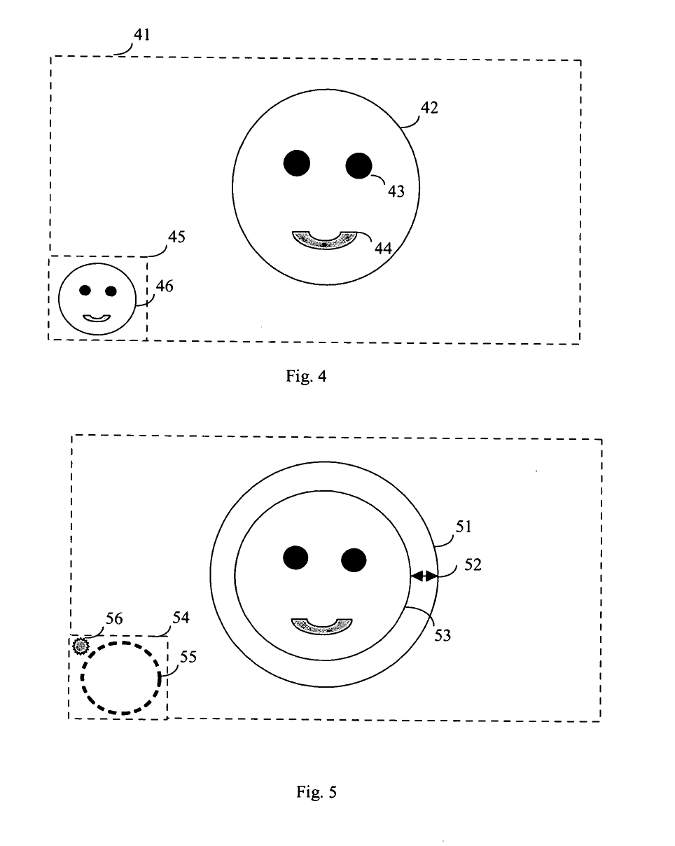

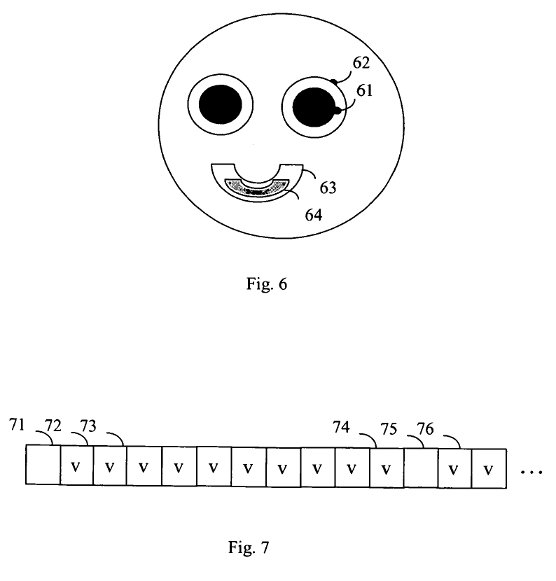

One of the advantages of this invention of the wireless video compression is adaptively assigning variable bit rate to the pixels within the variable regions. From the other hand, as shown in FIG. 4 some block of pixels are background and won't attract more attention will be assigned less data bits, the regions with important object like the head 42, eyes 43, mouth 44, . . . will be assigned more bits. When shooting video, the captured frame will be shrunk to be a smaller size 45 of picture and displayed in a location within a display screen to inform what the region/object 46 he/she is capturing. There are many ways of shrinking an image including but not limited to selecting only one of every couple of pixels, taking average of a couple of pixels.. the later results in better image quality with the cost of computing power.

For saving the computing power, shrinking captured image and displaying to a predetermined location of the display device can be done once every predetermined duration time, like once a second or once every 3 seconds or twice a second.

For improving the image quality and reducing the bit rate, this invention predetermines the Region Of Interest, ROI, for instance, the face 53 of a human being as shown in FIG. 5 and a surrounding range 51 which covers the possible area of vibration or potential movement from frame to frame. During compression, those pixels within a ring 51 is deemed as the same critical then the interior of the face and is compressed by assigning more bit rate than other region accordingly. For example, pixels within the ring of the face will be compressed by a factor of 10 times while, other area might be compressed by a factor of 50× time. The display device will have a small display area showing the shrunk image of the video shooter him/herself to help more accurately focus on the ROI. One of a part of this invention is to draw a shrunk image 55 on the area 54 of the display screen as the reference to help the video shooting more easily focusing on the ROI. When the shrunk image a user is shooting fits the predetermined area, a signal 56 on the display device will signal and represent “good quality”.

For further optimizing the image quality or/and reducing the bit rate, the region of interest, ROI can also be partitioned into multiple ROI 61, 64 with each ROI having variable compression rate within the predetermined surrounding area 62, 63. For instance, the face area has 20 times compression rate, mouth area has 10 times compression rate and the eyes have 5 times compression rate, other area like background have 50 times compression rate.

In this invention of the audio and video communication, the compressed audio and video data are packed separately and be interlaced as data stream with predetermined package size of each pack of audio and video as shown in FIG. 7. The audio pack 71, 75 are inserted to the video packs 72, 73, 74, 76 with a predetermined rate of audio pack number and video pack number.

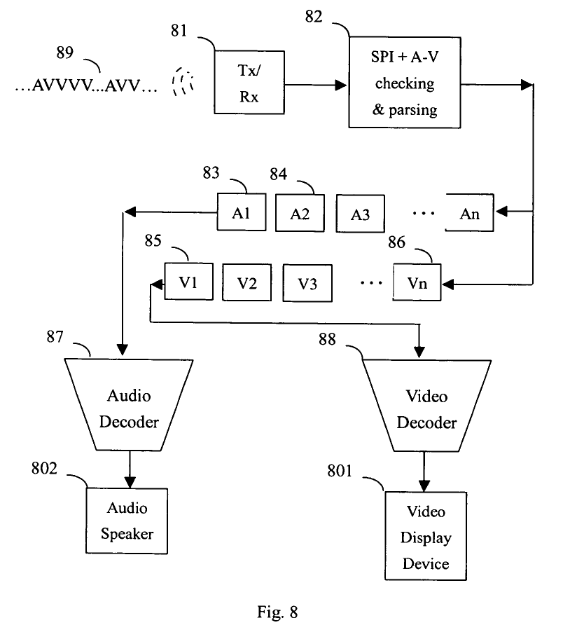

For example, the compressed audio data rate is 16K bits per second (bps), and the video rate is 160K bps, then, every pack of audio data is interleaved 89 with 10 packs of video data as shown in FIG. 8. And when the receiver 81 obtains the audio and video packs of data, it checks the correctness, separates the audio and video packs 82 and sends the audio data 83, 84 to the audio decoder 87 and the video data 85, 86 to the video decoder 88. The decoded audio stream will then be driven out to the speaker 802 and the decoded video stream being displayed on to a screen 801.

Wireless video communication has high chance of coming across the data loss and even higher chance of data damage, like transmitting a “0” and receiving a “1”. One of the most common solution of handling the data loss or data damage is to check whether the received data has the same amount and value of the transmitted data. If the data amount is wrong, it is called data loss, if the data value is wrong, it is named data damage. The common way of recovering the data loss and data damage is to request “Re-send”.

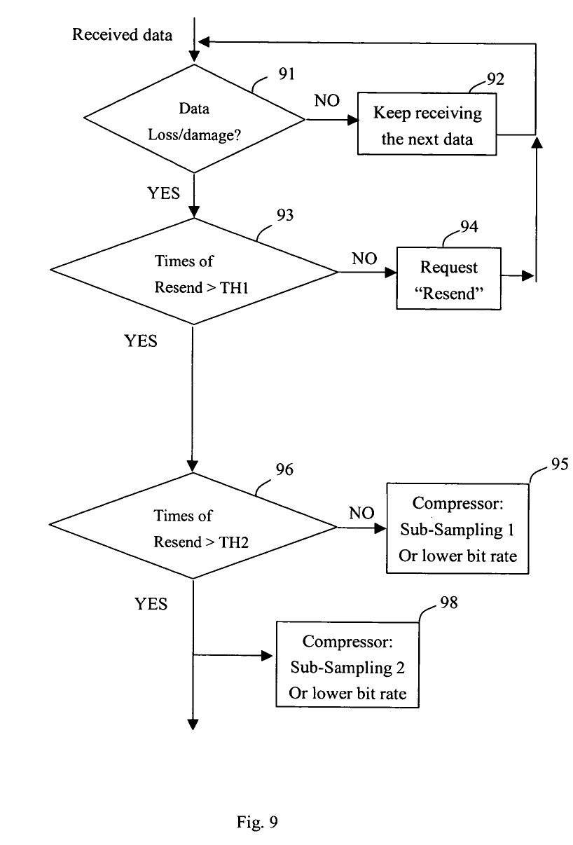

This invention of the wireless video communication applies new method to overcome the impact of the data loss or data damage in the air as in the flowchart illustrated in FIG. 9. After receiving a predetermined amount of data, a data loss or/and damage 91 checking mechanism is enabled. If no data loss or damage, this device will keep receiving the next data 92. Should data loss/damage happened, it will firstly check whether the times of requesting “re-send” is over a predetermined threshold (TH1), if less than TH1, then, requesting “Re-send” 94 will be issued. Any time a re-send signal is sent, both receiver and transmitter will update the counter of resend. If the re-send time is greater than the TH1 and less than TH2, the transmitter will inform the compression unit to reduce the data rate either by sub-sampling 95 with the first sampling rate or increasing the compression rate. For instance, the original compressed data rate is 320K bps, when the data loss/damage happened and the times of requesting re-send is over TH1 and less than TH2, the data rate could be reduced to 160K bps by sub-sampling, selecting one of every 2 pixels and compress with the same compression rate or selecting the same pixels and increasing the compression rate by another 2 times. Should the times of re-send is greater 96 than TH2, the transmitter will inform the compression unit to reduce the data rate either by sub-sampling 98 with the second sampling rate 98 or increasing the compression rate. Every time the number of re-send is greater than a threshold number, TH1 or TH2, the current group of pixels will be discarded and the compression unit will re-start compression from the next group of pixels. And in the receiver will inform the display unit to display the current group of pixels by displaying the same group of pixels of the previous image. Since from frame to frame in a short time, the content will not change much, by applying this mechanism, the image quality degradation will be minimized. The data loss and damage rate is exponentially proportional to the amount of a pack data transmitting out to the air at a predetermined duration time. A pack of data can be defined as the data amount for one time bursting out to the air for transmission. To avoid the rate of data loss and data damage, the duration of transmission and the data amount of a pack are reduced. Should the data loss or data damage happened, the data amount of a pack of bursting will be reduced further.

A CRC program calculating a “cyclical redundancy check” values for the data specified. In effect, CRC checking performs a calculation on every byte in the file, generating a unique number for the file in question. If so much as a single byte in the file being checked were to change, the cyclical redundancy check value for that file would also be changed. If the received data value is wrong, the CRC checking engine in this invention will record and be reported to indicate the problem of data damage and the video decompression unit gives up decompressing of the current group of pixels and waits for the next group of pixels with correct data.

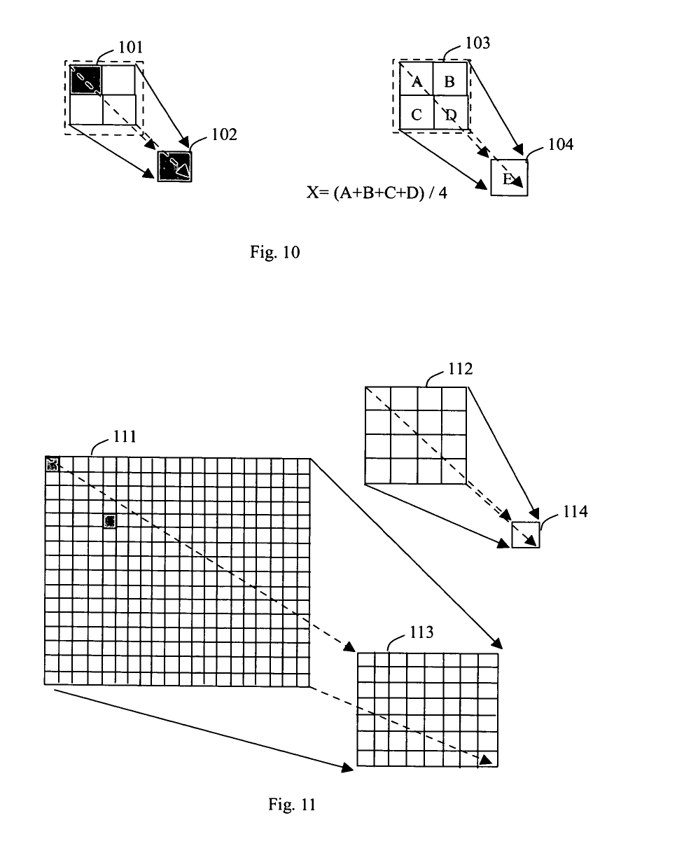

FIG. 10 illustrates some principles of the sub-sampling pixels. An easiest way is to select one 102 of a group 101 of pixels, said 1 of 4 pixels. Another method of sub-sampling is to take the average value 104 of a group 103 of pixels. FIG. 11 shows a whole frame of image 111 is shrunk to a smaller image 113 by regularly sub-sampling a group of pixels 112 into smaller group of pixels 114.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of wireless video communication, comprising:
capturing the image through an image sensor device, compressing the captured image group by group and sending the compressed image through a wireless transmitter;
receiving the compressed image stream through a wireless receiver, if no data loss or data damage happened, the received compressed data is sent to a display device to decompress and to display, should the data loss happened, then:
if the times of resend is less than the first predetermined threshold, then, requesting the transmitter to resend the lost pack of the compressed data,
if the times of resend is more than the first predetermined threshold and less than the first predetermined threshold, then, no more request of resend, and lower down the bit rate by either sub-sampling with the first predetermined sampling rate or increasing the compression rate;
if the times of resend is more than the second predetermined threshold, then, lower down the bit rate by either sub-sampling with the second sampling rate or further increase the compression rate.

2. The method of claim 1, wherein the group of pixels within a predetermined region has fixed number of pixels.

3. The method of claim 2, wherein the group of pixels is comprised of a line of pixels with Y, U/Cb, V/Cr or R, G, B format.

4. The method of claim 2, wherein the group of pixels is comprised of a block of M×N pixels with Y, U/Cb, V/Cr or R, G, B format.

5. The method of claim 1, wherein the length of a pack data of the next transmission is reduced if data loss or data damage happened.

6. The method of claim 1, when times of resending is over a predetermined threshold when data loss or data damage happened, the sub-sampling mechanism takes the average of a group of pixels to represent pixels of a group, then, compress and decompress them accordingly.

7. The method of claim 1, when times of resending is over a predetermined threshold when data loss or data damage happened, the compressor will compress the future packs of pixels by assigning less bit rate than which is assigned to previous packs of data.

8. A method of capturing video and compressing the video data with optimized image quality, comprising:
depicting the shape of the predetermined first targeted object on an area of the display device and showing the captured image with reduced bit number and comparing it to the drawn shape of the first targeted object;
signaling whether or not the main object of the image being captured is within a predetermined range of video shooting; and
compressing the pixels of the image with at least two predetermined compression ratios for the area having more important object being assigned more bit rate and the area of less interest with less bit rate.

9. The method of claim 8, the groups of pixels within predetermined areas with not the first targeted object are compressed and transmitted at a duration time which is longer than that for those groups of pixels of area with the first targeted object.

10. The method of claim 8, the groups of pixels within predetermined areas with not the first targeted object are compressed and transmitted at a duration time which is longer than that for those groups of pixels of area with the first targeted object.

11. The method of claim 9, the groups of pixels within predetermined areas with not the first targeted object are compressed and transmitted at least every other frame of captured image.

12. The method of claim 8, the image of displaying for the video shooter to view the position he/she is capturing is captured, shrunk at a duration time of at least every other frame of captured image.

13. The method of claim 8, wherein when the position of shooting area matches the predetermined area, a signal light will turn on a predetermined color to indicate “right position”.

14. The method of claim 8, wherein a sub-sampling mechanism is applied to shrink the captured image to be displayed to indicate the position of the video frame shooting.

15. A device of capturing video data, compressing and decompressing the image for wireless transmitting, receiving and image displaying, comprising:
an image sensor device capturing the image data;
a compression unit reducing the data rate of the captured video and transmitting it group by group through a wireless transmitter;
a decompression unit recovering the received video data through the wireless receiver;
a data checking unit calculating the amount and values of the received data and comparing to the amount and values of the transmitted data amount and deciding whether data loss or data damage happened in the air during wireless transmission, and if data loss or data damage happened, instructing the compression and display units to take action to minimize the degradation of the image quality; and
a display device receiving the compressed image data and the location of displaying, then decompressing the data and driving out the pixels to display screen accordingly.

16. The device of claim 15, wherein the display is comprised of a display panel and a display driver with a decompression engine and a storage device temporarily saving the reconstructed image to be driven out to be displayed.

17. The device of claim 15, wherein the data checking unit is comprised of a CRC, “cyclical redundancy check” code checking circuitry, calculating values for the files one specifies.

18. The device of claim 15, wherein the data checking unit finds data damage, if the timer of error shows not over the threshold, it ignores the error, if the error times is over a predetermined number, the engine will issue a request of resend.

19. The device of claim 15, wherein the data checking unit identifies the data damage and gives up requesting of resend if the time of resend is more than a predetermined number.

20. The device of claim 15, wherein should the data checking unit decides to give up request of resend when data loss or data damage happened, the video decompression unit gives up decompressing of the current group of pixels and compresses the next group of pixels with correct data.
